(19) United States
(12) Patent Application Publication
(10) Pub. No.: US 2026/0103134 A1
(43) Pub. Date: Apr. 16, 2026

(54) SYSTEMS, DEVICES, AND METHODS FOR A TOWABLE MOBILITY DEVICE AND/OR CARGO LIFT FOR A VEHICLE

(71) Applicant: Toyota Motor North America, Inc., Plano, TX (US)

(72) Inventor: Gabriel E. Marciano, Corinth, TX (US)

(73) Assignees: Toyota Motor North America, Inc., Plano, TX (US); Toyota Jidosha Kabushiki Kaisha, Toyota-shi (JP)

(21) Appl. No.: 18/916,539

(22) Filed: Oct. 15, 2024

(51) Int. Cl. B60P 1/02; B60D 1/48; B60D 1/64; B60G 15/00; B60P 3/06; B60Q 1/34; B60Q 1/44; B60R 16/033

(52) U.S. Cl. CPC B60P 1/022; B60D 1/481; B60D 1/64; B60P 3/06; B60R 16/033; B60G 15/00; B60Q 1/34; B60Q 1/44

(57) ABSTRACT

Systems, devices, and methods for a towable lift system for lifting and transporting a mobility device and/or cargo. The system may include a frame and a plurality of wheels rotatably coupled to the frame such that the system may be towed by a vehicle. The system may include a platform configured to hold the mobility device and/or the cargo. The platform may have a stowed position for transporting the mobility device and/or the cargo and a deployed position for loading or unloading the mobility device and/or the cargo from the platform on a left side or a right side of the system. The system may include a lift configured to move the platform between the stowed position and the deployed position. The system may include one or more actuators configured to actuate the lift to move the platform between the stowed position and the deployed position.

### BACKGROUND

### 1. Field

The present disclosure relates to systems, devices, and/or methods for a towable mobility device and/or cargo lift for a vehicle.

### 2. Description of the Related Art

Mobility devices (e.g., electric wheelchairs, scooters, etc.) may assist users with mobility. However, due to the weight of mobility devices (e.g., 200 pounds or more), transporting the mobility device itself is generally difficult and associated with high costs. For example, a mobility van that is configured to transport a mobility device (e.g., by having a built-in ramp to load the mobility device in the mobility van) may cost upwards of $100,000. Moreover, current devices or vehicles for transporting mobility devices may not be able to transport the mobility devices over unpaved surfaces (e.g., offroad trails). In addition, current devices or vehicles are generally not compatible with a broad range of mobility devices. For example, certain mobility devices may be too heavy to lift and/or transport for the current devices or vehicles.

Moreover, certain types of cargo (e.g., boxes, containers, pallets, etc.) may be too heavy to lift and/or transport for users and/or the current devices or vehicles. For example, a large box may be too heavy for a user to lift on to a bed of a truck or into a trunk of a vehicle.

Accordingly, it is desirable to provide systems, devices, and methods for a towable mobility device and/or cargo lift for a vehicle.

### SUMMARY

In general, one aspect of the subject matter described in this disclosure may be embodied in a towable lift system for lifting and transporting a mobility device and/or cargo. The towable lift system may include a frame. The frame may have a front end, a rear end, and a top side positioned between the front end and the rear end. The towable lift system may further include a plurality of wheels rotatably coupled to the frame such that the towable lift system may be towed by a vehicle. The towable lift system may further include a platform configured to hold the mobility device and/or the cargo. The platform may have a stowed position for transporting the mobility device and/or the cargo with the platform being positioned above the top side of the frame when in the stowed position. The platform may further have a deployed position for loading or unloading the mobility device and/or the cargo from the platform with the platform being in contact with a surface on a left side or a right side of the towable lift system when in the deployed position. The towable lift system may further include a lift having a proximal end coupled to the frame and a distal end coupled to the platform. The lift may be configured to move the platform between the stowed position and the deployed position. The towable lift system may further include one or more actuators coupled to the lift. The one or more actuators may be configured to actuate the lift to move the platform between the stowed position and the deployed position.

In one aspect, the subject matter may be embodied in a towable mobility device lift system for lifting and transporting a mobility device. The towable mobility device lift system may include a frame. The frame may have a front end, a rear end, and a top side positioned between the front end and the rear end. The towable mobility device lift system may further include a hitch connector positioned at the front end of the frame and configured to removably attach to a trailer hitch of a vehicle. The towable mobility device lift system may further include a trailer hitch positioned at the rear end of the frame and configured to removably attach to a hitch-mounted accessory or a trailer. The towable mobility device lift system may further include a plurality of wheels rotatably coupled to the frame such that the towable mobility device lift system may be towed by the vehicle. The towable mobility device lift system may further include a platform configured to hold the mobility device. The platform may have a stowed position for transporting the mobility device with the platform being positioned above the top side of the frame when in the stowed position. The platform may further have a deployed position for loading or unloading the mobility device from the platform with the platform being in contact with a surface on a left side or a right side of the towable mobility device lift system when in the deployed position. The towable mobility device lift system may further include a multi-linkage lift arm having a proximal end coupled to the frame and a distal end coupled to the platform. The multi-linkage lift arm may be configured to move the platform between the stowed position and the deployed position.

### BRIEF DESCRIPTION OF THE DRAWINGS

Other systems, methods, features, and advantages of the present disclosure will be apparent to one skilled in the art upon examination of the following figures and detailed description. Component parts shown in the drawings are not necessarily to scale and may be exaggerated to better illustrate the important features of the present disclosure. In the drawings, like reference numerals designate like parts throughout the different views.

FIG. 1 illustrates a side view of an example towable lift system and an example trailer being towed by an example vehicle according to an aspect of the disclosure.

FIG. 2 illustrates a side view of the towable lift system of FIG. 1 with a platform of the towable lift system being in an example stowed position according to an aspect of the disclosure.

FIG. 3 illustrates a side view of the towable lift system of FIG. 1 with the platform of the towable lift system being in an example deployed position according to an aspect of the disclosure.

FIG. 4 illustrates a side view of an example mobility device on an example platform according to an aspect of the disclosure.

FIG. 5 illustrates a rear view of the towable lift system of FIG. 1 with the platform of the towable lift system being in an example deployed position according to an aspect of the disclosure.

FIG. 6 illustrates a side view of the towable lift system of FIG. 1 without certain features shown to better illustrate an example suspension system of the towable lift system according to an aspect of the disclosure.

FIG. 7 illustrates a side view of the towable lift system of FIG. 1 without certain features shown to better illustrate an example suspension system of the towable lift system according to an aspect of the disclosure.

FIG. 8 illustrates a side view of the towable lift system of FIG. 1 having example suspension systems according to an aspect of the disclosure.

FIG. 9 illustrates a side view of the towable lift system of FIG. 1 having a variation of a lift according to an aspect of the disclosure.

FIG. 10 illustrates a side view of the towable lift system of FIG. 1 with a platform of the towable lift system being in an example stowed position according to an aspect of the disclosure.

FIG. 11 illustrates a side view of the towable lift system of FIG. 1 with a platform of the towable lift system being in an example stowed position according to an aspect of the disclosure.

### DETAILED DESCRIPTION

Disclosed herein are systems, devices, methods, and/or vehicles for implementing a towable lift system. Particular embodiments of the subject matter described in this disclosure may be implemented to realize one or more of the following advantages. The towable lift system (also known as a lift device or mechanism) may include a platform configured to hold and move a mobility device (e.g., electric wheelchairs, scooters, etc.) and/or cargo (e.g., boxes, containers, pallets, etc.). The platform may have a stowed position for transporting the mobility device and/or the cargo and a deployed position for loading or unloading the mobility device and/or the cargo from the platform. The towable lift system may further include a lift and/or motor for moving the platform between the stowed position and the deployed position. For the deployed position, the lift may place the platform on the ground to the left side or the right side of the towable lift system such that the mobility device and/or the cargo may be loaded or unloaded from the platform. This advantageously allows the platform to be moved to both sides of the vehicle or trailer thus allowing for greater versatility. Also, the lift system can lift and move a broad range of mobility devices and/or cargo, such as mobility devices and/or cargo that weigh 750 pounds or less (or 1,000 pounds or less, or other weights).

Moreover, the towable lift system may further include a hitch connector that may enable the towable lift system to be towed by a vehicle to transport the mobility device and/or the cargo. In addition, the towable lift system may include a trailer hitch for attaching a hitch-mounted accessory and/or a trailer to the towable lift system. This may enable the vehicle to tow the towable lift system and the hitch-mounted accessory and/or the trailer simultaneously.

Moreover, the towable lift system may have a minimal tongue weight (e.g., less than 200 pounds or less than 100 pounds) and may require no specialized equipment or modification to a vehicle to be towed by the vehicle. This may enable the towable lift system to be towed by a large range of vehicles. For example, the towable lift system may include an onboard battery for powering the lift such that the towable lift system does not require the vehicle to power the towable lift system. In contrast, current devices (e.g., devices that may be attached to vehicles via a trailer hitch of the vehicles) for transporting mobility devices and/or cargo are often too heavy for certain types of vehicles and/or may require modification of the vehicles. For example, current devices may have a tongue weight of over 200 pounds or over 500 pounds when transporting a mobility device and/or cargo and/or may require specialized power supplies to be retrofitted to the vehicles. This may prevent certain vehicles (e.g., sedans) from utilizing current devices to transport mobility devices and/or cargo and/or may require high costs to modify the vehicles.

Moreover, the towable lift system may include a plurality of wheels having a large outer diameter (e.g., more than 20 inches, 25 inches, or 30 inches) and/or one or more suspension systems that may enable the towable lift system to be towed at higher speeds (e.g., 55 miles per hour, 65 miles per hour, 75 miles per hour, etc.) than current devices and may prevent the towable lift system from adversely affecting the ride quality of the towing vehicle. In addition, the large outer diameter of the plurality of wheels and the one or more suspension systems may enable the towable lift system to be towed across unpaved surfaces such as offroad trails. The towable lift system may have 0, 2, or 4 wheels and be positioned between a front vehicle (e.g., a towing vehicle) and a rear towed vehicle (e.g., a trailer). The towable lift system has a front hitch to connect to the front vehicle and a rear hitch to connect to the rear towed vehicle.

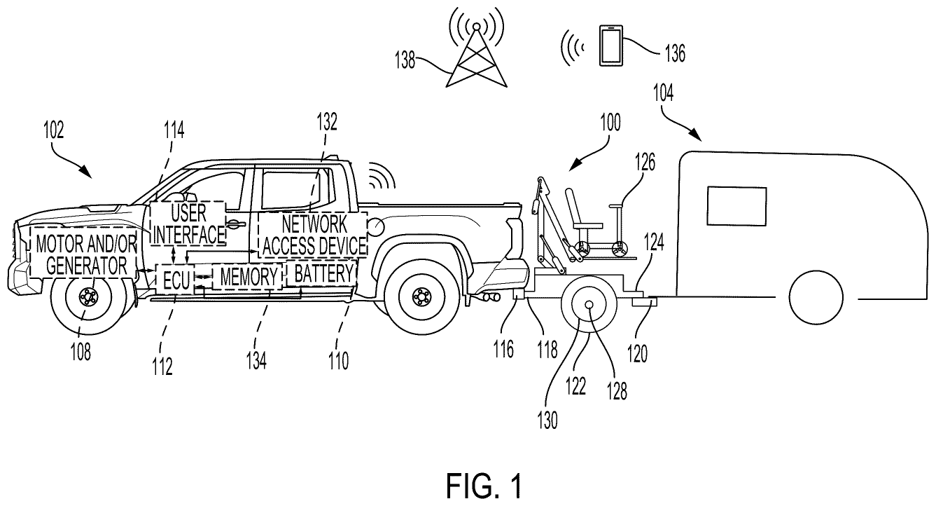

FIG. 1 illustrates a side view of an example vehicle 102 towing an example towable lift system 100 (also may be referred to as a towable mobility device lift system 100). The towable lift system 100 or a portion thereof may be retrofitted, coupled to, include, or be included with the vehicle 102 or separate from the vehicle 102. The vehicle 102 may be a conveyance capable of transporting a person, an object, or a permanently or temporarily affixed apparatus. The vehicle 102 may be a self-propelled wheeled conveyance, such as a car, a sports utility vehicle, a truck, a bus, a van, a motorcycle, or any other type of vehicle. For example, the vehicle 102 may be an electric vehicle, a hybrid vehicle, a plug-in hybrid vehicle, a hydrogen fuel cell vehicle, or any other type of vehicle that has a fuel cell, a motor, an engine, and/or a generator. Other examples of vehicles include trains or any other form of conveyance that is capable of transportation. The vehicle 102 may be semi-autonomous or autonomous. That is, the vehicle 102 may be self-maneuvering and navigate without human input. An autonomous vehicle may have and use one or more sensors and/or a navigation unit to drive autonomously.

The vehicle 102 may include a motor and/or generator 108, a battery 110, an electronic control unit (ECU) 112, a memory 134, a network access device 132, and/or a user interface 114. The motor and/or generator 108 may be located within an engine bay of the vehicle 102. The motor and/or generator 108 may be an internal combustion engine (ICE). In this regard, the motor and/or generator 108 may combust an air and fuel mixture to provide power to the vehicle 102 and/or components of the vehicle 102 and/or the towable lift system 100. Accordingly, the motor and/or generator 108 can cause the vehicle 102 to accelerate, decelerate, or maintain a desired velocity. In examples, the motor and/or generator 108 may include combinations of an ICE and an electric motor, such as for hybrid electric vehicle (HEV) applications, for example. In examples, the motor and/or generator 108 may be an electric motor, such as for battery electric vehicle (BEV) applications, for example. In this regard, the motor and/or generator 108 may be an electric motor and an electric generator that converts electrical energy into mechanical power, such as torque, and converts mechanical power into electrical energy. The motor and/or generator 108 may be electrically connected to the battery 110. The motor and/or generator 108 may convert energy from the battery 110 into mechanical power, and may provide energy back to the battery 110, for example, via regenerative braking. The battery 110 may be electrically connected to the motor and/or generator 108 and may provide electrical energy to and/or receive electrical energy from the motor and/or generator 108. The battery 110 may provide electrical energy to the towable lift system 100, in examples.

The vehicle 102 may further include one or more processors, such as the ECU 112. The ECU 112 may be implemented as a single ECU or in multiple ECUs. The ECU 112 may be electrically connected to some or all of the components of the vehicle 102 and/or the towable lift system 100 (e.g., via a controller area network (CAN) bus and/or other protocols). The ECU 112 may include one or more processors (or controllers) specifically designed for controlling operations of the vehicle 102, such as accelerating, braking, controlling a panoramic view monitor (PVM) of the vehicle 102, etc. In examples, the ECU 112 may be and/or include an advanced driver assistance systems (ADAS) sensor fusion ECU, a panoramic view monitor (PVM) ECU, an engine control module (ECM), a transmission control module (TCM), a telematics control unit (TCU), an in-vehicle infotainment (IVI) ECU, and/or a graphics processing unit (GPU).

The memory 134 may be electrically connected to the ECU 112. In examples, the memory 134 may be communicatively coupled (e.g., via a network 138) to the ECU 112 such that the memory 134 is remote from the ECU 112 and/or the vehicle 102. In other examples, the memory 134 may be electrically connected to the ECU 112 and a remote memory (e.g., a remote database) may be communicatively coupled to the ECU 112, with the remote memory having similar, additional, and/or different functions as the memory 134 (e.g., greater storage capacity, enabling over-the-air updates, etc.). The memory 134 may store instructions to execute on the ECU 112 and may include one or more of a random access memory (RAM) or other volatile or non-volatile memory. The memory 134 may be a non-transitory memory or a data storage device, such as a hard disk drive, a solid-state disk drive, a hybrid disk drive, or other appropriate data storage, and may further store machine-readable instructions, which may be loaded and executed by the ECU 112.

The network access device 132 may be electrically connected to the ECU 112 and may include a communication port or channel, such as one or more of a Wi-Fi unit, a Bluetooth® unit, a Radio Frequency Identification (RFID) tag or reader, a DSRC unit, and/or a cellular and/or satellite network unit for accessing the network 138 (e.g., CDMA, GSM, 3G, 4G, 5G, etc.). The network access device 132 may transmit data to and receive data from devices and systems not directly connected to the vehicle 102. For example, the ECU 112 may communicate with a user device 136 that is within or remote from the vehicle 102. The user device 136 may be a mobile phone (e.g., utilizing one or more applications), a watch, a tablet, a laptop, a key fob, or other computing devices. In examples, a user (e.g., an owner of the vehicle 102) may control one or more functions of the vehicle 102 via the user device 136, such as locking or unlocking the vehicle 102 and/or starting or turning off the vehicle 102, for example.

The user interface 114 may be electrically connected to the ECU 112. The user interface 114 may be located within a cabin of the vehicle 102 (e.g., coupled to a dashboard of the vehicle 102). The user interface 114 may provide an interface to the user of the vehicle 102 to interact with and/or receive output from the ECU 112. The user interface 114 may have a user interface element, such as one or more screens and/or one or more touchscreens with a button, a switch, a microphone, a speaker, a gesture monitoring sensor, a knob, a graphical user interface (GUI), and/or other input/output devices electrically connected to the ECU 112 to provide input and/or output of information (or data) to and/or from the ECU 112.

The vehicle 102 may further include a trailer (or tow) hitch 116 (e.g., SAE class III, class IV, etc.). The trailer hitch 116 may receive and/or removably couple to various hitch-mounted accessories (e.g., ball mounts, bike racks, cargo carriers, etc.) and/or trailers (e.g., a trailer 104). The trailer hitch 116 may be configured to removably couple to the towable lift system 100 to tow the towable lift system 100, for example. The vehicle 102 may include a wiring connector that is configured to electrically connect with a wiring connector of a hitch mounted accessory, a trailer (e.g., the trailer 104), and/or the towable lift system 100, for example. The wiring connector of the vehicle 102 may supply electrical energy and/or data to and/or may receive electrical energy and/or data from the hitch mounted accessory, the trailer, and/or the towable lift system 100, for example. The trailer 104 may be a recreational vehicle (RV), a boat trailer, a flat bed trailer, a horse trailer, a travel trailer, a utility trailer, or any other trailer that may be towed by the vehicle 102. In examples, the trailer 104 may electrically connect with the vehicle 102 such that data and/or electrical energy may be transmitted between the vehicle 102 and the trailer 104 (e.g., via respective wiring connectors of the trailer 104 and the vehicle 102).

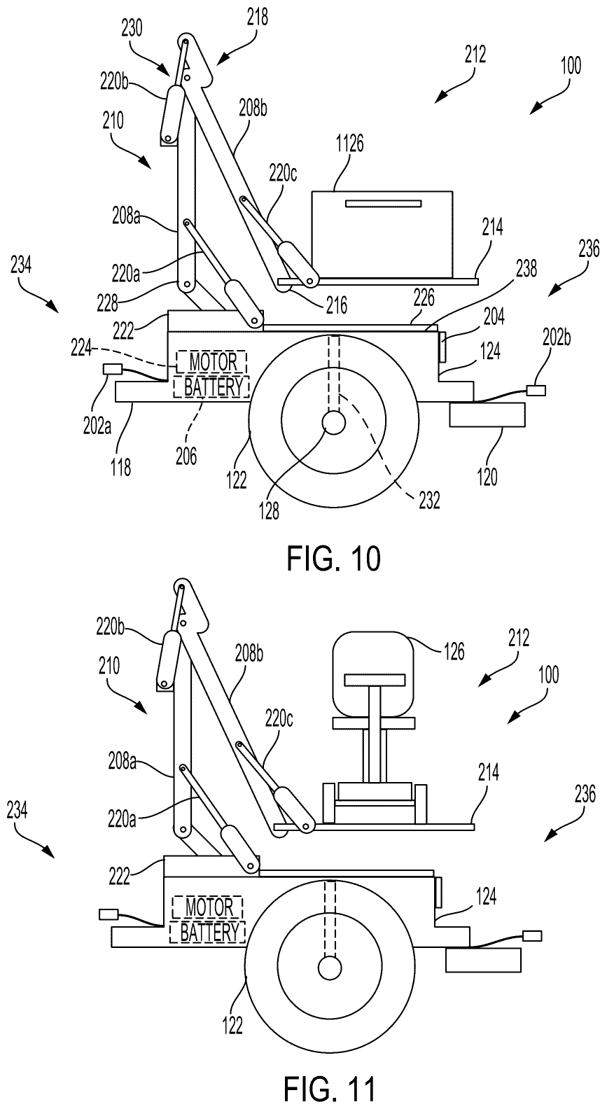

The towable lift system 100 may be configured to hold and transport a mobility device 126 and/or cargo 1126 (marked in FIG. 10). In examples, the towable lift system 100 may be configured to hold, load and unload, and transport a plurality of mobility devices and/or the cargo 1126. The towable lift system 100 may automatically load and unload one or more mobility devices at specific stops programmed using the ECU 112. The mobility device 126 may be a manual wheelchair, an electric wheelchair, a scooter, a bicycle, an electric bicycle, a golf cart, a moped, or any other manual or power-driven device that assists one or more users with mobility. The cargo 1126 may be one or more boxes, one or more containers, one or more pallets, and/or one or more of any transportable object.

The towable lift system 100 may include a plurality of wheels 122 and a frame 124. The plurality of wheels 122 may enable the towable lift system 100 to roll and be towed by the vehicle 102 to transport the towable lift system 100 (and the mobility device 126 and/or the cargo 1126 (marked in FIG. 10) carried by the towable lift system 100). The plurality of wheels 122 may include two wheels (e.g., a left wheel and a right wheel). In examples, the plurality of wheels 122 may include more than two wheels. The plurality of wheels 122 may be rotatably coupled to the frame 124 via one or more axles 128. The plurality of wheels 122 may be connected to the same axle or different axles. The plurality of wheels 122 may each have a rim 130 that is configured to receive a tire. The plurality of wheels 122 may have a large outer diameter (e.g., more than 20 inches, more than 25 inches, or more than 30 inches). This may have the benefit of improving the on road and/or offroad performance of the towable lift system 100. For example, the large outer diameter of the plurality of wheels 122 may enable the towable lift system 100 to roll over speed bumps, rocks, or other obstacles and may prevent the plurality of wheels 122 from getting stuck in and/or damaged by potholes, for example. Moreover, the large outer diameter of the plurality of wheels 122 may improve the stability of the towable lift system 100 when it is being towed by the vehicle 102 and may raise the speed at which the towable lift system 100 may be towed, for example. The plurality of wheels 122 may be attached to an electric motor, which is used to power the plurality of wheels 122 in sync with the wheels of the vehicle 102 and/or the trailer 104.

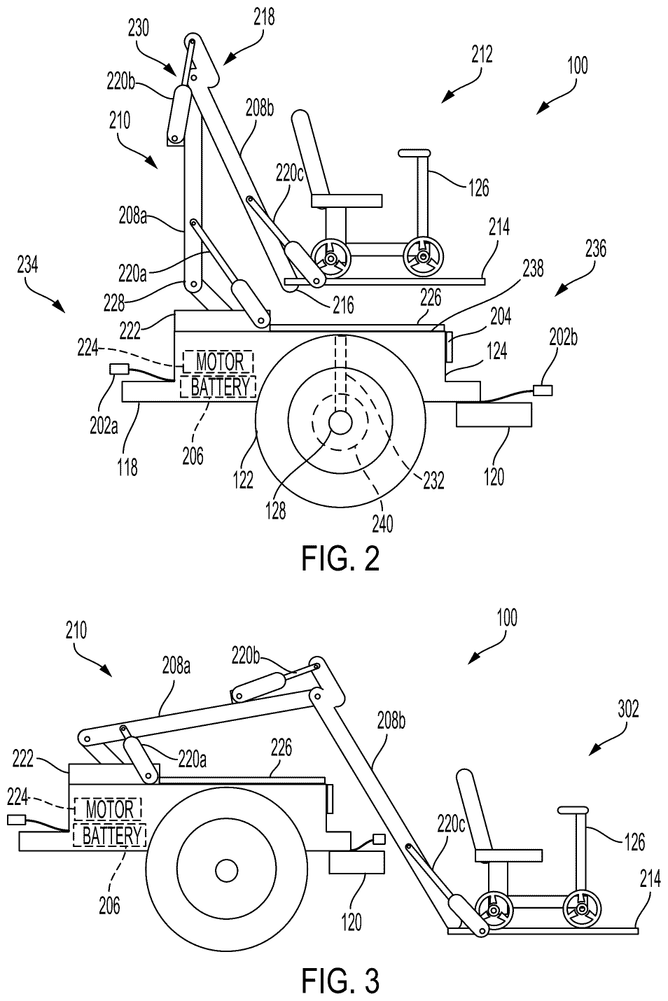

FIG. 2 illustrates a side view of the towable lift system 100. Referring to FIG. 2 with continuing reference to FIG. 1, the frame 124 may be a structure that forms a chassis or main body of the towable lift system 100. In examples, the frame 124 may be a tubular structure and/or solid beam structure that is made of aluminum, steal, and/or other metals or composite materials. The frame 124 may have a rectangular shape (in examples, the frame 124 may have a different shape). The frame 124 may include one or more panels forming a housing for one or more components of the towable lift system 100 (e.g., a first motor 224, a battery 206, etc.). The frame 124 may include a front end 234 and a rear end 236 opposite the front end 234. The frame 124 may include a top side (or surface) 238 positioned between the front end 234 and the rear end 236.

The towable lift system 100 may further include a front hitch connector 118. The hitch connector 118 may be connected to the front end 234 of the frame 124, for example. The hitch connector 118 may be configured to be removably attached to a trailer hitch, such as the trailer hitch 116 of the vehicle 102, for example. The hitch connector 118 may enable the towable lift system 100 to be towed by the vehicle 102. In examples, the hitch connector 118 may be a bar or a tube (e.g., a square bar or tube) that is configured to be inserted into the trailer hitch 116. Accordingly, the hitch connector 118 may form a direct and/or a fixed connection between the frame 124 and the trailer hitch 116 such that the frame 124 moves with the vehicle 102. This may reduce the difficulty of reversing the vehicle 102 while towing the towable lift system 100 due to the reduced or eliminated possibility of the towable lift system 100 jackknifing. In examples, the hitch connector 118 may be configured to connect with the trailer hitch 116 such that that the hitch connector 118 and/or the frame 124 does not move or pivot horizontally relative to the vehicle 102, but may move or pivot vertically relative to the vehicle 102. For example, the hitch connector 118 may include a pivot such that the frame 124 may move or pivot vertically about the pivot of the hitch connector 118.

In examples, the hitch connector 118 and/or other components of the towable lift system 100 may allow for a minimal range of horizontal movement (e.g., less than 20 degrees, less than 10 degrees, etc.) between the trailer hitch 116 of the vehicle 102 and the towable lift system 100. This may improve the ability of the towable lift system 100 to follow the vehicle 102. In examples, the plurality of wheels 122 may be configured to turn relative to the frame 124 to follow a direction of the vehicle 102. For example, the towable lift system 100 may further include a vertical spindle 232. The vertical spindle 232 may be coupled to the one or more axles 128 and the frame 124. The vertical spindle 232 may form a vertical axis of rotation of the one or more axles 128. That is, the one or more axles 128 (and thus the plurality of wheels 122) may turn a minimal amount (e.g., less than 20 degrees, less than 10 degrees, etc.) about the vertical spindle 232. This may allow the plurality of wheels 122 to better follow the vehicle 102 as the towable lift system 100 is towed behind the vehicle 102 without having the risk of jackknifing. In examples, the towable lift system 100 may include other turning or steering systems such that the plurality of wheels 122 are able to turn and follow a direction of the vehicle 102.

The towable lift system 100 may further include a first wiring connector 202a. The first wiring connector 202a may be positioned proximate the front end 234 of the frame 124. The first wiring connector 202a may be configured to connect with a wiring connector of a vehicle that is towing the towable lift system 100, such as the wiring connector of the vehicle 102, for example. For example, the first wiring connector 202a may be configured to connect to a standardized 4, 5, 6, or 7 way wiring connector or other types of wiring connectors. The towable lift system 100 may receive electrical energy and/or data from the vehicle 102 via the first wiring connector 202a. In examples, in addition or alternatively, the towable lift system 100 may provide electrical energy and/or data to the vehicle 102 via the first wiring connector 202a.

In examples, the towable lift system 100 may further include brakes 240 (e.g., trailer brakes, drum brakes, disk brakes, etc.). The brakes 240, for example, may be controlled by the vehicle 102 (e.g., via the ECU 112) when the first wiring connector 202a is connected with the wiring connector of the vehicle 102. In examples, the brakes 240 may be and/or include regenerative brakes that are configured to provide electrical energy to the towable lift system 100 and/or the vehicle 102 (e.g., the battery 110) via regenerative braking. For example, the brakes 240 may be and/or include a generator that converts kinetic energy of the vehicle 102 and/or the towable lift system 100 to electrical energy.

The towable lift system 100 may further include a rear trailer (or tow) hitch 120 (e.g., SAE class III, class IV, etc.). The trailer hitch 120 may be connected to the rear end 236 of the frame 124, for example. The trailer hitch 120 may be configured to receive and/or removably attach to various hitch-mounted accessories (e.g., trailer hitch ball mounts, bike racks, cargo carriers, etc.) and/or trailers (e.g., the trailer 104). The trailer hitch 120 may be configured to removably attach to the trailer 104 such that the vehicle 102 may tow the towable lift system 100 and the trailer 104, for example. In examples, a tongue weight of the trailer 104 may be supported by the towable lift system 100 and not the vehicle 102. Moreover, the towable lift system 100 may have a minimal to zero tongue weight when towed by the vehicle 102, in examples. Thus, the towable lift system 100 may enable a broader range of vehicles to tow the towable lift system 100 and a trailer (e.g., the trailer 104).

The towable lift system 100 may further include a second wiring connector 202b. The second wiring connector 202b may be positioned proximate the rear end 236 of the frame 124. The second wiring connector 202b may be configured to connect with a wiring connector of a hitch mounted accessory and/or the trailer 104, for example. The second wiring connector 202b may supply and/or receive electrical energy and/or data to and/or from the hitch mounted accessory and/or the trailer 104, for example. In examples, the towable lift system 100 may electrically connect the trailer 104 to the vehicle 102 (e.g., via the first wiring connector 202a and the second wiring connector 202b) such that the vehicle 102 may supply and/or receive electrical energy and/or data to and/or from the trailer 104.

For example, the vehicle 102 may activate (e.g., via the ECU 112) one or more lights 204 of the towable lift system 100 and/or one or more lights of the trailer 104 by transmitting electrical energy and/or data to the towable lift system 100 via the first wiring connector 202a and/or to the trailer 104 via the second wiring connector 202b. The one or more lights 204 of the towable lift system 100 may include one or more brake lights, one or more reverse lights, one or more license plate lights, and/or one or more turn signals. The vehicle 102 may control (e.g., via the ECU 112) the one or more lights 204 and/or the one or more lights of the trailer 104 when the vehicle 102 is towing the towable lift system 100 and/or the trailer 104 to signal to other users (e.g., other drivers, pedestrians, etc.) that the vehicle 102 is braking, turning, and/or reversing.

In examples, the towable lift system 100 may further include the battery 206. The battery 206 may be configured to power various components of the towable lift system 100 (e.g., the one or more lights 204, the first motor 224, etc.). In examples, the battery 206 may be configured to recharge the mobility device 126. For example, the towable lift system 100 may include one or more outlets that the mobility device 126 can be plugged into to recharge the mobility device 126 via the battery 206 and/or electrical energy from the vehicle 102. The battery 206 may enable the towable lift system 100 to operate without needing electrical energy from the vehicle 102. This may increase the compatibility of the towable lift system 100 with vehicles because the vehicles (e.g., the vehicle 102) do not need to support a specific power output. In examples, the battery 206 may be recharged via electrical energy received from the vehicle 102 (e.g., via the first wiring connector 202a). In addition or alternatively, the battery 206 may be recharged via one or more solar panels 226. The one or more solar panels 226 may be coupled to the top side 238 of the frame 124, for example. In examples, the one or more solar panels 226 may be coupled to the vehicle 102 (e.g., a roof of the vehicle 102) and may be electrically connected to the battery 206 (e.g., via the first wiring connector 202a). In addition or alternatively, the battery 206 may be recharged by the brakes 240 via regenerative braking.

The towable lift system 100 may further include a platform 214 and a lift (or lift arm) 210. The platform 214 may be moveably coupled or fixedly coupled to the lift 210. The platform 214 may be configured to hold and move the mobility device 126 and/or the cargo 1126 (marked in FIG. 10) such that the mobility device 126 and/or the cargo 1126 may be transported (e.g., via the vehicle 102 towing the towable lift system 100). The platform 214 may have a rectangular shape, for example (in examples, the platform 214 may have a different shape). In examples, the platform 214 may be configured to hold and move the mobility device 126 as shown in FIGS. 2 and 3 (e.g., with the mobility device 126 facing toward the rear of the towable lift system 100). In examples, the platform 214 may be configured to hold the mobility device 126 such that the mobility device 126 faces toward the front of the towable lift system 100 or the rear of the towable lift system 100. In addition or alternatively, in examples, the platform 214 may be configured to hold the mobility device 126 as shown in FIG. 11 (e.g., with the mobility device 126 being positioned horizontally relative to the towable lift system 100).

The platform 214 may have a stowed (or first) position 212 (as shown in FIG. 2) and a deployed (or second) position 302 (as shown in FIG. 3). In the stowed position 212, the platform 214 may securely hold the mobility device 126 and/or the cargo 1126 (marked in FIG. 10) for transport of the mobility device 126 and/or the cargo 1126 (e.g., via the vehicle 102 towing the towable lift system 100). In the stowed position 212, the platform 214 may be positioned above the top side 238 of the frame 124. In examples, the platform 214 may be spaced apart from the top side 238 of the frame 124 or may be in contact with the top side 238 of the frame 124 when in the stowed position 212. In the deployed position 302, the mobility device 126 and/or the cargo 1126 may be loaded or unloaded from the platform 214. In the deployed position 302, the platform 214 may be in contact with a surface (e.g., a ground surface, a street surface, a sidewalk surface, a trail surface, a truck bed surface, a dock surface, etc.) that is on a right side, a left side, or to the rear of the frame 124 and/or the towable lift system 100. This may improve the ease of loading or unloading the mobility device 126 and/or the cargo 1126 from the platform 214.

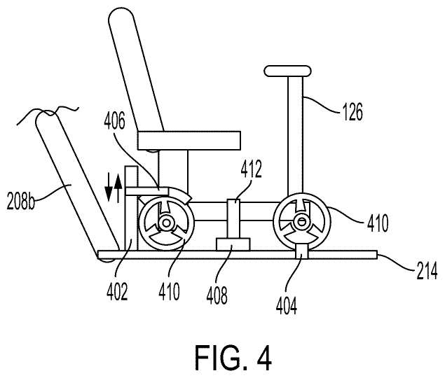

Referring briefly to FIG. 4, the platform 214 may include one or more securement points to hold and secure the mobility device 126 and/or the cargo 1126 (marked in FIG. 10) on the platform 214. For example, the one or more securement points may include one or more clamps or straps 404. The one or more clamps or straps 404 may clamp or strap on to the cargo 1126 and/or one or more wheels 410 of the mobility device 126 (or other components of the mobility device 126) to hold and secure the cargo 1126 and/or the mobility device 126 to the platform 214. In examples, the one or more securement points may include a backstop (or wall) 402 that may prevent the cargo 1126 and/or the mobility device 126 from sliding or rolling off the platform 214 and/or may locate the cargo 1126 and/or the mobility device 126 on the platform 214.

Moreover, the one or more securement points may include one or more wheel clamps 406. The one or more wheel clamps 406 may manually or automatically (e.g., via an actuator) clamp down onto a respective wheel 410 of the mobility device 126. For example, the one or more wheel clamps 406 may move up or down (e.g., along the backstop 402) to clamp down on a respective wheel 410 (or other component) of the mobility device 126.

In examples, the one or more securement points may include a strap dispenser 408 (or a plurality of strap dispensers). The strap dispenser 408 may contain a rolled up strap 412 that may be dispensed when pulled by a user. The strap 412 may be pulled over the cargo 1126 (marked in FIG. 10) and/or the mobility device 126 and an end of the strap 412 may be secured to the platform 214 (e.g., via one or more hooks or clips coupled to the platform 214). The strap dispenser 408 may be configured to manually or automatically lock (e.g., via a pin that manually or automatically locks a spindle of the strap dispenser 408) and/or tighten the strap 412 (e.g., via an actuator or a lever reversing the direction of the strap dispenser 408 to roll up the strap 412) to hold and secure the cargo 1126 and/or the mobility device 126 to the platform 214. Other configurations of securement points may be utilized in examples.

Referring again to FIG. 2, the lift 210 may include and/or be coupled to a base 222. The base 222 may connect the lift 210 to the frame 124 of the towable lift system 100. For example, the base 222 may be coupled to the top side 238 of the frame 124. The lift 210 may be a multi-linkage lift arm that includes a plurality of bars and that is actuated by a plurality of actuators. In examples, the lift 210 may be and/or include a crane, a scissor lift, or a ramp that is actuated by the plurality of actuators. The plurality of bars may include a first bar (or boom) 208a and/or a second bar (or arm) 208b. The first bar 208a may have a proximal end 228 and a distal end 230 opposite the proximal end 228. The second bar 208b may have a proximal end 218 and a distal end 216 opposite the proximal end 218 of the second bar 208b. The proximal end 228 of the first bar 208a may be moveably coupled (e.g., via a pivot or a joint) to the base 222. The distal end 230 of the first bar 208a may be moveably coupled (e.g., via a pivot or a joint) to the proximal end 218 of the second bar 208b. The distal end 216 of the second bar 208b may be moveably coupled (or fixedly coupled) to the platform 214.

The plurality of actuators may include a first actuator 220a, a second actuator 220b, and/or a third actuator 220c. In examples, the plurality of actuators may include less than three actuators or more than three actuators. The actuators 220a-c may be hydraulic cylinders, pneumatic cylinders, and/or electric actuators, for example.

The first actuator 220a may be coupled to the base 222 and the first bar 208a, for example. The first actuator 220a may be configured to move the first bar 208a (e.g., up and down) to change an angle of the first bar 208a relative to the base 222. In examples, the lift 210 may include a plurality of first actuators. The second actuator 220b may be coupled to the first bar 208a and the second bar 208b, for example. The second actuator 220b may be configured to move the second bar 208b (e.g., up and down) to change an angle of the second bar 208b relative to the first bar 208a and/or the base 222. In examples, the lift 210 may include a plurality of second actuators. The third actuator 220c may be coupled to the second bar 208b and the platform 214, for example. The third actuator 220c may be configured to move the platform 214 (e.g., up and down) to change an angle of the platform 214 relative to the second bar 208b (e.g., to keep the platform 214 level). In examples, the lift 210 may include a plurality of third actuators.

The plurality of actuators may further include the first motor 224. The actuators 220a-c may be connected to the first motor 224 (e.g., via one or more hydraulic and/or pneumatic lines). In examples, the towable lift system 100 may include a plurality of first motors. The first motor 224 may be housed within the frame 124 and/or the base 222 of the towable lift system 100, for example. The first motor 224 may be and/or include a hydraulic pump and/or a pneumatic pump, for example. The first motor 224 may be electrically connected to the battery 206. The first motor 224 may be configured to extend or retract the actuators 220a-c to move the lift 210 and/or the platform 214. The lift 210 and the platform 214 may be moved to the left and/or the right of the towable lift system 100.

Referring to FIGS. 2 and 3 with continuing reference to FIG. 1, the plurality of actuators 220a-c and/or 224 may be configured to actuate the lift 210 to move the platform 214 between the stowed position 212 (as shown in FIG. 2) and the deployed position 302 (as shown in FIG. 3). As shown in FIG. 3, the lift 210 may lower the platform 214 to a surface in the deployed position 302. This may allow a user to remove the mobility device 126 and/or the cargo 1126 (marked in FIG. 10) from the platform 214 or to secure the mobility device 126 and/or the cargo 1126 on the platform 214. The lift 210 may lower the platform 214 to the rear and/or the front of the frame 124 and/or the towable lift system 100, in examples. The lift 210 may have a lifting capacity of at least 750 pounds, for example. That is, the lift 210 may be able to lift mobility devices (e.g., the mobility device 126) and/or cargo (e.g., the cargo 1126) on the platform 214 that are equal to or less than 750 pounds. In examples, the lift 210 may have a lifting capacity of more than 750 pounds (e.g., 1000 pounds).

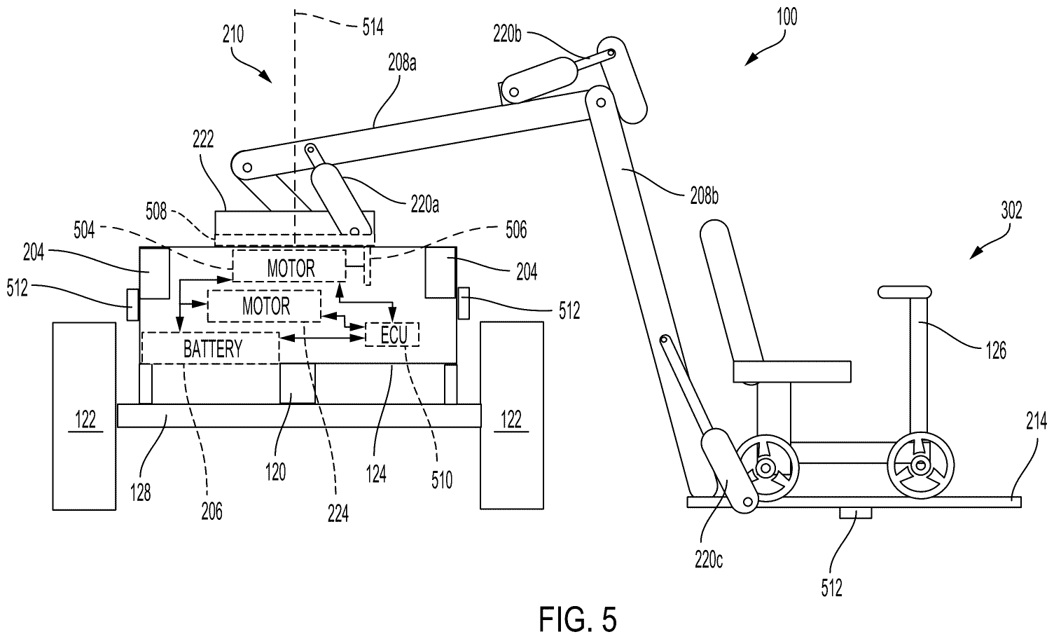

FIG. 5 illustrates a rear view of the towable lift system 100. Referring to FIG. 5 with continuing reference to FIGS. 1 and 2, in examples, moving the platform 214 from the stowed position 212 to the deployed position 302 may include lowering the platform 214 to a side of the frame 124 and/or the towable lift system 100. For example, the lift 210 may lower the platform 214 to the left side or the right side (as shown in FIG. 5) of the frame 124 and/or the towable lift system 100. Lowering the platform 214 to the left side or the right side of the frame 124 and/or the towable lift system 100 may be required when the trailer hitch 120 of the towable lift system 100 is attached to a hitch-mounted accessory (e.g., a trailer hitch ball mount, a bike rack, a cargo carrier, etc.) and/or a trailer (e.g., the trailer 104). Moreover, even if not required, lowering the platform 214 to the left side or the right side of the frame 124 and/or the towable lift system 100 may be more convenient for a user. For example, the vehicle 102 may be parked alongside a sidewalk and a user may desire to load or unload the mobility device 126 and/or the cargo 1126 (marked in FIG. 10) from the sidewalk. Accordingly, the user may choose to deploy the platform 214 to the deployed position 302 on the sidewalk and to the side of the frame 124 and/or the towable lift system 100.

To rotate the lift 210 and the platform 214 to the front, the rear, the left side, or the right side of the frame 124 and/or the towable lift system 100, the base 222 and/or the lift 210 may be configured to rotate. For example, the base 222 and/or the platform 214 may be configured to horizontally rotate about a vertical axis 514. In examples, the plurality of actuators may further include a second motor 504 located within the frame 124 and/or the base 222. The second motor 504 may be configured to horizontally rotate the base 222, the lift 210, and/or the platform 214 relative to the frame 124 and about the vertical axis 514. For example, the second motor 504 may rotate one or more gears 506 that engage a circular track 508 that is coupled to the base 222 or the frame 124 to rotate the base 222. Accordingly, the second motor 504 may be activated to rotate the base 222 and thus the lift 210 and the platform 214 between the front, the rear, the left side, and/or the right side of the frame 124 and/or the towable lift system 100. In examples, the base 222 may be configured to rotate 90 degrees, 180 degrees, or 360 degrees relative to the frame 124 (in examples, the base 222 may be configured to rotate a different amount).

The towable lift system 100 may further include one or more processors, such as an electronic control unit (ECU) 510. The ECU 510 may be implemented as a single ECU or in multiple ECUs. The ECU 510 may be electrically connected to some or all of the components of the towable lift system 100 and/or the vehicle 102 (e.g., via a controller area network (CAN) bus and/or other protocols). The ECU 510 may include one or more processors (or controllers) specifically designed for controlling operations of the towable lift system 100, such as controlling the plurality of actuators 220a-c, 224, and 504 to actuate the lift 210 to move the platform 214 between the stowed position 212 and the deployed position 302, and/or moving and/or locking or unlocking the one or more securement points of the platform 214. The ECU 510 may include and/or be electrically connected to a memory. The memory of the ECU 510 may store instructions to execute on the ECU 510 and may include one or more of a random access memory (RAM) or other volatile or non-volatile memory. The memory of the ECU 510 may be a non-transitory memory or a data storage device, such as a hard disk drive, a solid-state disk drive, a hybrid disk drive, or other appropriate data storage, and may further store machine-readable instructions, which may be loaded and executed by the ECU 510.

The ECU 510 may control the lift 210 (e.g., by controlling the plurality of actuators 220a-c, 224, and 504) to move the platform 214 between the stowed position 212 and the deployed position 302. The ECU 510 may control the lift 210 in response to receiving one or more signals. The one or more signals may indicate to move the platform 214 to the stowed position 212 or the deployed position 302 on the left side, the right side, or to the rear and/or the front of the frame 124 and/or the towable lift system 100. In examples, the ECU 510 may receive the one or more signals from one or more input devices (e.g., buttons, switches, dials, touch screens, etc.) electrically connected to the ECU 510 and coupled to the towable lift system 100. In examples, the towable lift system 100 may include a network access device (e.g., similar to the network access device 132) that may enable the ECU 510 to receive the one or more signals from the user device 136.

In addition or alternatively, the ECU 510 may receive the one or more signals from the vehicle 102 (e.g., via the ECU 112 and/or the first wiring connector 202a). For example, a user may utilize the user interface 114 of the vehicle 102 and/or the user device 136 to control the towable lift system 100. The ECU 112 of the vehicle 102 may receive the one or more signals from the user interface 114 and/or the user device 136 and may relay or transmit the one or more signals to the ECU 510 (e.g., via the first wiring connector 202a).

The towable lift system 100 may further include one or more sensors 512. The one or more sensors may be electrically connected to the ECU 510. The one or more sensors 512 may be coupled to the lift 210, the platform 214, and/or the frame 124, for example. The one or more sensors 512 may be and/or include a camera, a sonar sensor, a radar sensor, and/or a lidar sensor, for example. The one or more sensors 512 may measure, detect, and/or determine the proximity of one or more objects in a surrounding area of the towable lift system 100. For example, the one or more sensors 512 may measure, detect, and/or determine the proximity of the one or more objects by collecting spatial information of the one or more objects (e.g., to construct a point cloud). In examples, when the one or more sensors 512 detect and/or determine that the one or more objects are within a predetermined distance (e.g., 2 feet, 3 feet, etc.) of the towable lift system 100 and/or within a movement path of the platform 214, the towable lift system 100 (e.g., via the ECU 510) may stop and/or prevent the platform 214 from moving. The predetermine distance and/or the movement path of the platform 214 may be stored on the memory of the ECU 510, for example.

In addition or alternatively, in examples, the one or more sensors 512 may include one or more tilt sensors and/or one or more weight sensors. For example, the one or more tilt sensors may be and/or include an accelerometer, a gyroscope, an inclinometer, and/or a digital level. The one or more tilt sensors may be configured to measure, detect, and/or determine a tilt level of the towable lift system 100. When the one or more tilt sensors measure, detect, and/or determine that the tilt level of the towable lift system 100 is equal to or greater than a tilt threshold, the towable lift system 100 (e.g., via the ECU 510) may stop and/or prevent the platform 214 from moving and/or may move the platform 214 such that the tilt level of the towable lift system 100 falls below the tilt threshold. The tilt threshold may be stored in the memory of the ECU 510, for example. The one or more tilt sensors may prevent the towable lift system 100 from toppling over when the towable lift system 100 is on uneven and/or angled ground.

The one or more weight sensors may be and/or include a load cell, a force/torque sensor, a pressure sensor, and/or a weight scale. The one or more weight sensors may be configured to measure, detect, and/or determine a weight of the mobility device 126 and/or the cargo 1126 (marked in FIG. 10). When the one or more weight sensors measure, detect, and/or determine that the weight of the mobility device 126 and/or the cargo 1126 is equal to or greater than a weight threshold (e.g., 750 pounds, 800 pounds, etc.), the towable lift system 100 (e.g., via the ECU 510) may stop and/or prevent the platform 214 from moving. The weight threshold may be stored in the memory of the ECU 510, for example. The one or more weight sensors may prevent the towable lift system 100 from being damaged by lifting a mobility device and/or cargo that is too heavy.

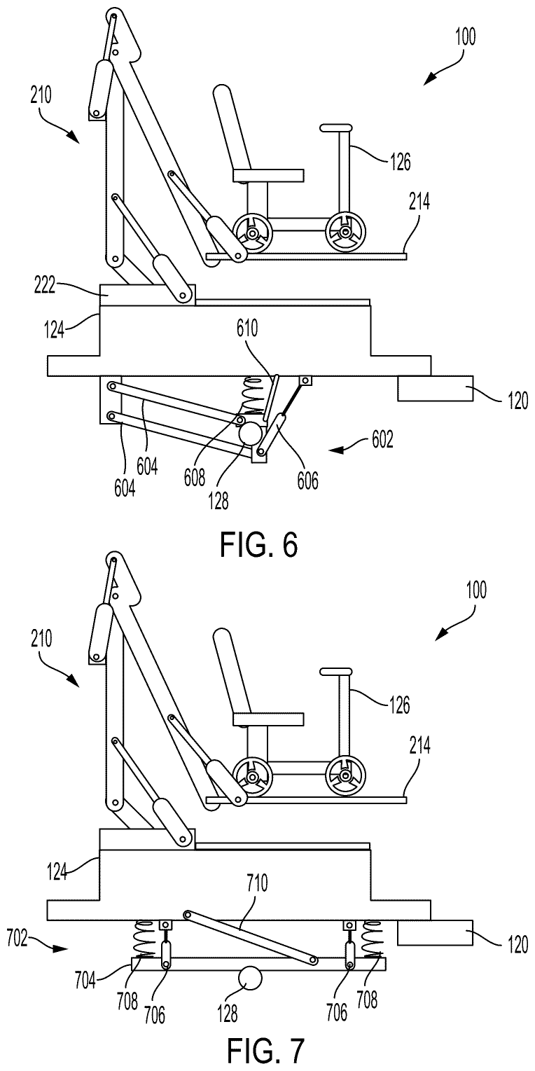

FIG. 6 illustrates a side view of the towable lift system 100 without the plurality of wheels 122 to better illustrate certain features of the towable lift system 100. Referring to FIG. 6 with continuing reference to FIG. 1, the towable lift system 100 may further include a suspension system 602. The suspension system 602 may couple the one or more axles 128 to the frame 124. The suspension system 602 may include a plurality of control arms 604 to secure and guide the one or more axles 128. For example, the plurality of control arms 604 may include a left control arm (or left upper and lower control arms) and a right control arm (or right upper and lower control arms). In examples, the suspension system 602 may further include a track bar 610, sway bars, and/or other components to secure and guide the one or more axles 128.

The suspension system 602 may further include a plurality of springs 608 and a plurality of dampers (or shock absorbers) 606 positioned between the frame 124 and the one or more axles 128. For example, the plurality of springs 608 may include a left spring and a right spring and the plurality of dampers 606 may include a left damper and a right damper. In examples, the plurality of springs 608 may be coil springs, air springs (or bags), and/or leaf springs. The plurality of springs 608 may support the weight of the towable lift system 100, the mobility device 126, the cargo 1126 (marked in FIG. 10), a hitch-mounted accessory (e.g., a trailer hitch ball mount, a bike rack, a cargo carrier, etc.), and/or the tongue weight of a trailer (e.g., the trailer 104). Moreover, the plurality of springs 608 may absorb energy from road or trail irregularities (e.g., bumps, potholes, etc.). The plurality of dampers 606 may control the rate at which the plurality of springs 608 compress and rebound to reduce oscillation (e.g., by controlling the dissipation of energy absorbed by the plurality of springs 608). This may ensure that the towable lift system 100 does not bounce but instead maintains stability. Accordingly, the suspension system 602 may ensure that the mobility device 126 and/or the cargo 1126 is transported smoothly across a variety of road or trail surfaces by isolating the mobility device 126, the cargo 1126, and/or the towable lift system 100 from irregularities on the road or trail surfaces. This may allow the vehicle 102 to tow the towable lift system 100 at higher speeds than if the towable lift system 100 did not have the suspension system 602.

FIG. 7 illustrates the towable lift system 100 having a suspension system 702. The suspension system 702 may be a variation of the suspension system 602. The suspension system 702 may couple the one or more axles 128 to the frame 124. The suspension system 702 may include a subframe 704 that is coupled to the one or more axles 128. The suspension system 702 may further include a plurality of control arms 710 configured to secure and guide the subframe 704 and/or the one or more axles 128.

The suspension system 702 may further include a plurality of springs 708 and a plurality of dampers (or shock absorbers) 706 positioned between the frame 124 and the subframe 704 and/or the one or more axles 128. For example, the plurality of springs 708 may include one or more left springs and one or more right springs and the plurality of dampers 706 may include one or more left dampers and one or more right dampers. In examples, the plurality of springs 708 may be coil springs, air springs (or bags), and/or leaf springs. The plurality of springs 708 may support the weight of the towable lift system 100, the mobility device 126, the cargo 1126 (marked in FIG. 10), a hitch-mounted accessory (e.g., a trailer hitch ball mount, a bike rack, a cargo carrier, etc.), and/or the tongue weight of a trailer (e.g., the trailer 104). The plurality of springs 708 and the plurality of dampers 706 may function the same or similar to the plurality of springs 608 and the plurality of dampers 606 of the suspension system 602. Accordingly, the suspension system 702 may ensure that the mobility device 126 and/or the cargo 1126 is transported smoothly across a variety of road or trail surfaces by isolating the mobility device 126, the cargo 1126, and/or the towable lift system 100 from irregularities on the road or trail surfaces. This may allow the vehicle 102 to tow the towable lift system 100 at higher speeds than if the towable lift system 100 did not have the suspension system 702.

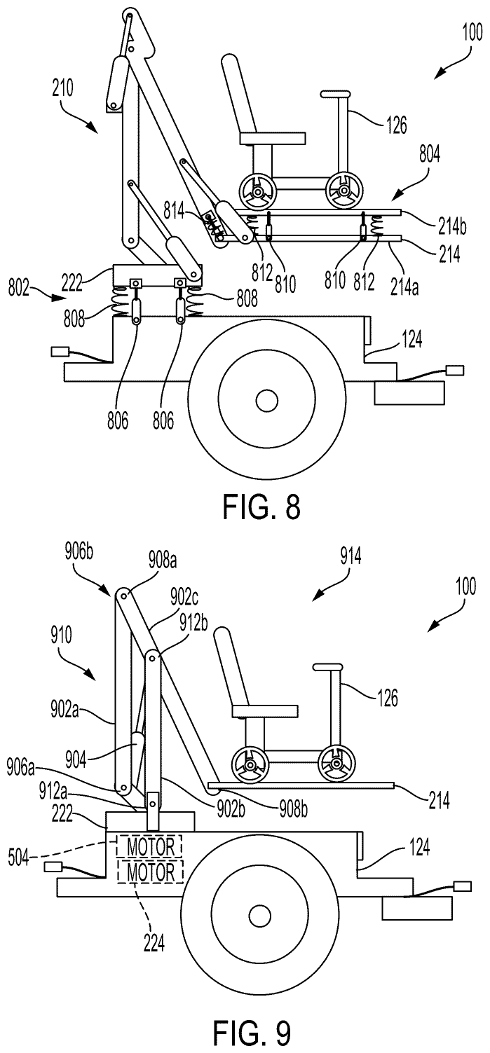

FIG. 8 illustrates the towable lift system 100 having a suspension system 802 and a suspension system 804. The suspension systems 802 and 804 may be variations of the suspension systems 602 and 702 or may be included in addition to the suspension systems 602 or 702. The suspension system 802 may include a plurality of springs 808 (e.g., four springs) and a plurality of dampers 806 (e.g., four dampers) positioned between the frame 124 and the base 222 such that the lift 210 and the mobility device 126 and/or the cargo 1126 (marked in FIG. 10) are isolated from road or trail irregularities. In examples, the plurality of springs 808 may be coil springs, air springs (or bags), and/or leaf springs. The suspension system 802 may include a plurality of control arms or other components to moveably couple the base 222 to the frame 124. The plurality of springs 808 may support the weight of the lift 210, the mobility device 126, and/or the cargo 1126. The plurality of springs 808 and the plurality of dampers 806 may function the same or similar to the plurality of springs 608 and the plurality of dampers 606 of the suspension system 602. Accordingly, the suspension system 802 may ensure that the mobility device 126 and/or the cargo 1126 is transported smoothly across a variety of road or trail surfaces by isolating the mobility device 126, the cargo 1126, and/or the towable lift system 100 from irregularities on the road or trail surfaces. This may allow the vehicle 102 to tow the towable lift system 100 at higher speeds than if the towable lift system 100 did not have the suspension system 802.

In examples, the towable lift system 100 may include the suspension system 804 in addition to or instead of one or more of the suspension systems 602, 702, and 802. The suspension system 804 may include a plurality of springs 812 (e.g., four springs) and a plurality of dampers 810 (e.g., four dampers) positioned between a lower portion 214a of the platform 214 and an upper portion 214b of the platform 214 such that the upper portion 214b of the platform 214 and the mobility device 126 and/or the cargo 1126 (marked in FIG. 10) are isolated from road or trail irregularities. In examples, the plurality of springs 812 may be coil springs, air springs (or bags), and/or leaf springs. The suspension system 804 may include a plurality of control arms or other components to moveably couple the lower portion 214a of the platform 214 to the upper portion 214b of the platform 214. The plurality of springs 812 may support the weight of the upper portion 214b of the platform 214, the mobility device 126, and/or the cargo 1126. The plurality of springs 812 and the plurality of dampers 810 may function the same or similar to the plurality of springs 608 and the plurality of dampers 606 of the suspension system 602. Accordingly, the suspension system 804 may ensure that the mobility device 126 and/or the cargo 1126 is transported smoothly across a variety of road or trail surfaces by isolating the mobility device 126 and/or the cargo 1126 from irregularities on the road or trail surfaces. This may allow the vehicle 102 to tow the towable lift system 100 at higher speeds than if the towable lift system 100 did not have the suspension system 804.

In examples, in addition or alternatively, the suspension system 804 may include one or more springs and/or dampers 814 coupled to the platform 214 and the lift 210 such that the platform 214 and the mobility device 126 and/or the cargo 1126 (marked in FIG. 10) are isolated from road or trail irregularities. The one or more springs and/or dampers 814 may function the same or similar to the plurality of springs 608 and the plurality of dampers 606 of the suspension system 602.

FIG. 9 illustrates a side view of the towable lift system 100 having a lift 910. The lift 910 may be a variation of the lift 210 (marked in FIG. 2). The lift 910 may include and/or be coupled to the base 222. The base 222 may couple the lift 910 to the frame 124 of the towable lift system 100. The lift 910 may be a four-bar linkage that includes a plurality of bars and that is actuated by a plurality of actuators. The plurality of bars may include a first bar 902a, a second bar 902b, and/or a third bar 902c, for example. The first bar 902a may have a proximal end 906a and a distal end 906b opposite the proximal end 906a. The second bar 902b may have a proximal end 912a and a distal end 912b opposite the proximal end 912a of the second bar 902b. The third bar 902c may have a proximal end 908a and a distal end 908b opposite the proximal end 908a of the third bar 902c. The proximal end 906a of the first bar 902a may be moveably coupled (e.g., via a pivot or a joint) to the base 222. The distal end 906b of the first bar 902a may be moveably coupled (e.g., via a pivot or a joint) to the proximal end 908a of the third bar 902c. The proximal end 912a of the second bar 902b may be moveably coupled (e.g., via a pivot or joint) to the base 222. The distal end 912b of the second bar 902b may be moveably coupled (e.g., via a pivot or a joint) to the third bar 902c. The distal end 908b of the third bar 902c may be moveably coupled (or fixedly coupled) to the platform 214.

The plurality of actuators may include a first actuator 904. The first actuator 904 may be moveably coupled to the base 222 and the third bar 902c and/or the second bar 902b, for example. In examples, at least one actuator of the plurality of actuators may be coupled to the platform 214 and the third bar 902c. The first actuator 904 may be a hydraulic cylinder, a pneumatic cylinder, and/or an electric actuator, for example. In examples, the plurality of actuators may include a plurality of first actuators. The first actuator 904 may be configured to move (e.g., up or down) the third bar 902c and/or the platform 214.

The plurality of actuators may include the first motor 224. The first actuator 904 may be connected to the first motor 224 (e.g., via one or more hydraulic and/or pneumatic lines). The first motor 224 may be configured to extend or retract the first actuator 904 to move the lift 910 and/or the platform 214.

The plurality of actuators 904 and/or 224 may be configured to actuate the lift 910 to move the platform 214 between a stowed (or first) position 914 and a deployed (or second) position (e.g., the same as or similar to the deployed position 302 shown in FIG. 3). The stowed position 914 may be the same as or similar to the stowed position 212 shown in FIG. 2. The lift 910 and the platform 214 may be rotated by the second motor 504 in the same or similar manner as the lift 210 (marked in FIG. 2) and may be controlled by the ECU 510 (marked in FIG. 5) in the same or similar manner as the lift 210.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A towable lift system for lifting and transporting a mobility device and/or cargo, the system comprising:
a frame having a front end, a rear end, and a top side positioned between the front end and the rear end;
a plurality of wheels rotatably coupled to the frame such that the towable lift system may be towed by a vehicle;
a platform configured to hold the mobility device and/or the cargo and having:
a stowed position for transporting the mobility device and/or the cargo, the platform being positioned above the top side of the frame when in the stowed position, and
a deployed position for loading or unloading the mobility device and/or the cargo from the platform, the platform being in contact with a surface on a left side or a right side of the towable lift system when in the deployed position;
a lift having a proximal end coupled to the frame and a distal end coupled to the platform and configured to move the platform between the stowed position and the deployed position; and
one or more actuators coupled to the lift and configured to actuate the lift to move the platform between the stowed position and the deployed position.

2. The system of claim 1, further comprising:
a hitch connector positioned at the front end of the frame and configured to removably attach to a trailer hitch of the vehicle; and
a trailer hitch positioned at the rear end of the frame and configured to removably attach to a hitch-mounted accessory or a trailer.

3. The system of claim 1, wherein the one or more actuators include one or more hydraulic cylinders, one or more pneumatic cylinders, and/or one or more electric actuators.

4. The system of claim 1, wherein the one or more actuators include a motor configured to horizontally rotate the lift relative to the frame such that the platform may be moved between the stowed position and the left side or the right side of the towable lift system.

5. The system of claim 1, further comprising a battery configured to provide electrical energy for moving the platform between the stowed position and the deployed position.

6. The system of claim 5, further comprising one or more solar panels coupled to the top side of the frame and configured to recharge the battery.

7. The system of claim 1, further comprising a wiring connector configured to electrically connect to a connector of the vehicle and receive electrical energy from the vehicle for moving the platform between the stowed position and the deployed position.

8. The system of claim 1, further comprising:
one or more axles coupled to the plurality of wheels; and
a suspension system coupled to the one or more axles and the frame and including a plurality of springs and a plurality of dampers for isolating the mobility device and/or the cargo from irregularities on a road surface or a trail surface when the towable lift system is being towed across the road surface or the trail surface.

9. The system of claim 1, further comprising a suspension system coupled to the platform and including one or more springs and one or more dampers for isolating the mobility device and/or the cargo from irregularities on a road surface or a trail surface when the towable lift system is being towed across the road surface or the trail surface.

10. The system of claim 1, wherein at least one of the one or more actuators is configured to horizontally rotate the platform 90 degrees, 180 degrees, or 360 degrees relative to the frame.

11. A towable mobility device lift system for lifting and transporting a mobility device, the system comprising:
a frame having a front end, a rear end, and a top side positioned between the front end and the rear end;
a hitch connector positioned at the front end of the frame and configured to removably attach to a trailer hitch of a vehicle;
a trailer hitch positioned at the rear end of the frame and configured to removably attach to a hitch-mounted accessory or a trailer;
a plurality of wheels rotatably coupled to the frame such that the towable mobility device lift system may be towed by the vehicle;
a platform configured to hold the mobility device and having:
a stowed position for transporting the mobility device, the platform being positioned above the top side of the frame when in the stowed position, and
a deployed position for loading or unloading the mobility device from the platform, the platform being in contact with a ground surface on a left side or a right side of the towable mobility device lift system when in the deployed position; and
a multi-linkage lift arm having a proximal end coupled to the frame and a distal end coupled to the platform and configured to move the platform between the stowed position and the deployed position.

12. The system of claim 11, further comprising one or more actuators coupled to the multi-linkage lift arm and configured to actuate the multi-linkage lift arm to move the platform between the stowed position and the deployed position.

13. The system of claim 12, wherein the one or more actuators include one or more hydraulic cylinders, one or more pneumatic cylinders, and/or one or more electric actuators.

14. The system of claim 12, wherein the one or more actuators include a motor configured to horizontally rotate the multi-linkage lift arm such that the platform may be moved between the stowed position and the left side or the right side of the towable mobility device lift system.

15. The system of claim 11, further comprising a battery configured to provide electrical energy for moving the platform between the stowed position and the deployed position.

16. The system of claim 15, further comprising one or more solar panels coupled to the top side of the frame and configured to recharge the battery.

17. The system of claim 11, further comprising:
one or more turn signals;
one or more brake lights; and
a wiring connector configured to electrically connect to a connector of the vehicle and receive electrical energy from the vehicle for:
moving the platform between the stowed position and the deployed position,
powering the one or more turn signals, and/or
powering the one or more brake lights.

18. The system of claim 11, further comprising:
one or more axles coupled to the plurality of wheels; and
a suspension system coupled to the one or more axles and the frame and including a plurality of springs and a plurality of dampers for isolating the mobility device from irregularities on a road surface or a trail surface when the towable mobility device lift system is being towed across the road surface or the trail surface.

19. The system of claim 11, further comprising a suspension system coupled to the platform and including one or more springs and one or more dampers for isolating the mobility device from irregularities on a road surface or a trail surface when the towable mobility device lift system is being towed across the road surface or the trail surface.

20. The system of claim 11, wherein the plurality of wheels are configured to turn relative to the frame to follow a direction of the vehicle.
